(19) United States
(12) Patent Application Publication
(10) Pub. No.: US 2011/0198516 A1
(43) Pub. Date: Aug. 18, 2011

(54) SHIELDING FOR COMPACT RADIATION SOURCES

(75) Inventors: Jiajin Fan, Philadelphia, PA (US); Chang Ming Ma, Huntington Valley, PA (US)

(73) Assignee: Fox Chase Cancer Center, Jenkintown, PA (US)

(21) Appl. No.: 12/681,019

(22) PCT Filed: Oct. 1, 2008
(86) PCT No.: PCT/US08/78389

§ 371 Date: Jun. 8, 2010

Related U.S. Application Data
(60) Provisional application No. 60/976,518, filed on Oct. 1, 2007.

(51) Int. Cl. G21F 1/12

(52) U.S. Cl. 250/518.1; 250/515.1

(57) ABSTRACT

Disclosed are radiation shields substantially enclosing a source of polyenergetic positive ions. The shielding layers are spatially arranged to absorb substantially all unwanted radiation arising directly or indirectly from the polyenergetic positive Also disclosed are methods of shielding unwanted radiation leaking from a system providing a therapeutic dose of polyenergetic positive radiation, as well as shielded polyenergetic positive ion selection systems.

### CROSS-REFERENCE TO RELATED APPLICATIONS

This application claims the benefit of U.S. Provisional Application No. 60/976,518 filed Oct. 1, 2007. This application is herein incorporated by reference in its entirety.

### TECHNICAL FIELD

The present invention pertains to the field of devices for blocking radiation.

### BACKGROUND

The use of proton beams provide the possibility of superior dose conformity to a treatment target compared to photon beams. Proton beams also provide better normal tissue sparing as a result of the Bragg Peak effect. While photons show high entrance dose and slow attenuation with depth, protons have a very sharp peak of energy deposition at the target region with lower entrance dose, sharper penumbra, and rapid falloff beyond the treatment depth.

Proton beams have been used for biomedical studies since the early 1950s. The first human patient was treated for a pituitary tumor in 1954, and since then about forty thousand patients have been treated with proton beams worldwide. Treatment records have shown encouraging results particularly for well-localized radio-resistant lesions. Despite the dosimetric superiority, the utilization of proton therapy has lagged behind that using photons and electrons because the facilities for proton therapy employing cyclotron and synchrotron technology are expensive and complex. An accelerator that is big enough to accelerate protons to the required therapeutic energies can cost in excess of $50 million dollars. Protons are difficult to handle and shield. The cost of big gantries and treatment room shielding increases the total capital cost to about $100 million for a proton facility. Even if a proton or ion facility can be amortized for 30 years or longer, its maintenance, upgrade, and operational cost will be significantly higher than that for a linac-based facility of similar treatment capacity. This situation could be greatly improved if a compact, flexible and cost-effective proton therapy system becomes available. This would enable the widespread use of this superior beam modality and therefore bring significant advances to the management of cancer.

Laser accelerated protons typically have a much broader energy distribution compared to protons generated using a synchrotron or cyclotron. Accordingly, new radiation shields, especially compact radiation shields, are needed to stop the radiation produced by a laser accelerated proton ion facility.

### SUMMARY

In one aspect the invention provides for a radiation shield substantially enclosing a source of polyenergetic positive ions, comprising: one or more electron shielding layers; one or more low energy proton shielding layers; one or more high energy proton shielding layers; and wherein said shielding layers are spatially arranged to absorb substantially all unwanted radiation arising directly or indirectly from the polyenergetic positive ions.

In another aspect, the present invention provides a method of shielding unwanted radiation leaking from a system providing a therapeutic dose of polyenergetic positive radiation, the method comprising: stopping or slowing electrons using one or more electron shielding layers contained within the system; stopping or slowing low energy protons using one or more low energy proton shielding layers contained within the system; and stopping or slowing high energy protons using one or more high energy proton shielding layers contained within the system.

In additional aspects, the present invention provides a polyenergetic positive ion selection system, comprising: a source of polyenergetic positive ions; and a radiation shield substantially enclosing the source of polyenergetic positive ions, the radiation shield comprising: one or more electron shielding layers; one or more low energy proton shielding layers; and one or more high energy proton shielding layers; wherein said shielding layers are spatially arranged to absorb substantially all unwanted radiation arising directly or indirectly from the polyenergetic positive ions.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1. depicts an embodiment of a particle collimating and energy selection device according to the present invention; a laser pulse is initialized to the left of the target foil and propagates from the left to the right side of the diagram; the desired protons move initially along the x-axis, deflect in the field, and return to the x-axis after traversing the magnetic field; the unwanted particles are either stopped by the collimators and stoppers, or absorbed by the surrounding shielding walls; the solid line that bends up through the energy selection collimator and then bends down through the secondary collimator represents the proton beam, while the dashed line represents the electron stream.

FIG. 2(A) depicts an energy distribution of protons from laser plasma acceleration generated in the device of FIG. 1; about 0.023% of protons has energy in range of Error! Objects cannot be created from editing field codes.

FIG. 2(B) depicts an energy distribution of electrons from laser plasma acceleration generated in the device of FIG. 1.

FIG. 3(A) depicts the modulated energy spectrum to deliver SOBP dose distribution of a Error! Objects cannot be created from editing field codes. cm2 field shown in FIG. 3(B).

FIG. 3(B) depicts the SOBP dose distribution of 4×4 cm² field; data shown in FIG. 3(B) is absorbed dose normalized to incident proton fluence.

FIG. 4 depicts a cross-sectional view of the geometry of a primary collimator model, showing the tally cell locations; the tally cells (A, B and C) are spheres with a radius of 2 cm.

FIG. 5(A) depicts the neutron dose equivalent spectra per incident proton as a function of neutron energy at detector A with 10 cm thick different materials (a=0 cm, b=10 cm, c=0 cm).

FIG. 5(B) depicts the neutron dose equivalent spectra per incident proton as a function of neutron energy at detector A with tungsten as primary collimator material and add polyethylene of different thickness (a=0 cm, b=10 cm, c=0, 2, 4, 6, 8, 10 cm).

FIG. 5(C) depicts the neutron dose equivalent spectra per incident proton as a function of neutron energy at detector A with composite collimator designs (a=2 cm, b=8 cm).

FIG. 5(D) depicts the neutron dose equivalent spectra per incident proton as a function of neutron energy at detector B with composite collimator designs (a=2 cm, b=8 cm).

FIG. 5(E) depicts the effect of different thickness ratio of steel-tungsten composite collimator design.

FIG. 5(F) depicts the neutron absorption ability difference of pure polyethylene and 5% boroned polyethylene (a=0 cm, b=10 cm, c=0, 6 cm) in energy range of 0.01 MeV and 300 MeV.

FIG. 6(A) depicts photons' effective dose from electron beam at forward and backward directions.

FIG. 6(B) depicts the neutron dose equivalent spectra generated by photonuclear interactions at forward and backward directions.

FIG. 7(A) depicts the spatial distribution of protons along the A-B direction on the surface of the shielding wall in a particle selection system with magnetic fields of 4.4 T; positions A, B, C and D are defined in FIG. 1.

FIG. 7(B) depicts the spatial distribution of protons along the C-B direction on the left surface of energy selection collimator in a particle selection system with magnetic fields of 4.4 T; positions A, B, C and D are defined in FIG. 1.

FIG. 7(C) depicts the spatial distribution of electrons along the A-D direction on the right surface of primary collimator and electron beam stopper in a particle selection system with magnetic fields of 4.4 T; positions A, B, C and D are defined in FIG. 1.

FIG. 8(A) depicts the results that were recorded by detector D (see FIG. 9) of the cumulative photon dose by using different thickness of electron beam stopper; the photon dose comes from primary collimator backscatter and is also plotted in the figure for analysis; all of the results are presented in Sv per therapeutic absorbed dose.

FIG. 8(B) depicts the results that were recorded by detector E (see FIG. 9) of the cumulative photon dose by using different thickness of electron beam stopper; the photon dose comes from primary collimator backscatter and is also plotted in the figure for analysis; all of the results were presented in Sv per therapeutic absorbed dose.

FIG. 9 depicts a cross-sectional view of an embodiment of an entire geometry model, showing the tally cell locations; the collimation and particle selection system is surrounded by a polyethylene layer and an outer lead layer while the top inner side has an extra steel layer to stop low energy protons; all the detectors except G are located at a distance of 100 cm from primary collimator left surface center; detector G is located at 50 cm away from the secondary collimator.

FIG. 10(A) depicts the dose equivalent per therapeutic absorbed dose (H/D) of neutrons at different detectors around the treatment head with no shielding in place; contributions from primary proton source and secondary proton source are shown separately; total contributions from both proton sources are also shown.

FIG. 10(B) depicts the dose equivalent per therapeutic absorbed dose (H/D) of neutrons at different detectors around the treatment head with a polyethylene shielding layer in place; contributions from primary proton source and secondary proton source are shown separately. Total contributions from both proton sources are also shown.

FIG. 10(C) depicts the dose equivalent per therapeutic absorbed dose (H/D) of gamma rays at different detectors around the treatment head with a polyethylene shielding layer in place; contributions from primary proton source and secondary proton source are shown separately. Total contributions from both proton sources are also shown.

FIG. 10(D) depicts the dose equivalent per therapeutic absorbed dose (H/D) of gamma rays at different detectors around the treatment head with both a polyethylene shielding layer and a lead shielding layer in place; contributions from primary proton source and secondary proton source are shown separately. Total contributions from both proton sources are also shown.

FIG. 11 depicts the dose equivalent per therapeutic absorbed dose H/D, in units of Sv/Gy around treatment head at different detectors displayed in FIG. 9.

FIG. 12 depicts one possible arrangement of the shielding layers along the top surface of the radiation shield; the inner most layer of shielding is low energy proton shielding. The next layer is low energy neutron shielding; the outer most layer is a high energy photon shielding layer.

FIG. 13 depicts the various types of radiation that are generated and stopped throughout the system.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. When any variable occurs more than one time in any constituent or in any formula, its definition in each occurrence is independent of its definition at every other occurrence. Combinations of substituents and/or variables are permissible only if such combinations result in stable compounds.

Referring to FIG. 13 the present invention provides a radiation shield 300 substantially enclosing a source of polyenergetic positive ions. These polyenergetic positive ions have many uses, including treatment of cancer. The invention provides various layers of shielding including: one or more electron shielding layers 318; one or more low energy proton shielding layers 302; one or more high energy proton shielding layers 326; and one or more secondary particle shielding layers. These shielding layers are spatially arranged to absorb substantially all unwanted radiation arising directly or indirectly from the polyenergetic positive ions.

The use of laser accelerated polyenergetic positive ions allows the source of those polyenergetic positive ions to be compact and movable, by a gantry for instance. It is beneficial for the radiation shield 300 to be designed efficiently and compactly to make use of these advantages.

Embodiments of the invention provide a basic structure that includes the aforementioned multiple shield layers, spatially arranged to absorb substantially all unwanted radiation arising directly or indirectly from the polyenergetic positive ions. These shielding layers can be assembled within thin (2-4 mm) structural containers made of steel (or other easy-to-machine materials such as aluminum or copper). These structural containers can be assembled together with screws or other fastening devices. This structural assembly will have minor effects on the shielding results, which are negligible in the overall system design. Suitable dimensions of the radiation shield 300 are about 1 m long by 1 m wide by 1 m high (m=“meter”). The dimensions of the shield are not limited. Small designs are preferred, however, as the bigger the dimension of the shield gets, the less maneuverable the source of polyenergetic positive ions becomes. The design should be, but does not have to be, smaller than or equal to about 5 m long by 5 m wide by 5 m high.

Referring to FIG. 9, the invention further provides an entry opening 120 to permit the entry of a laser pulse to the target 124 a source of polyenergetic positive ions, and an exit opening 122 for permitting polyenergetic positive ions to exit the radiation shield 100. The entry opening 120 to permit entry of a laser pulse is from about 1 cm² to about 1600 cm². The exit opening 122 for permitting polyenergetic positive ions to exit the radiation shield 100 is from about 0.01 cm² to about 1600 cm². FIG. 9 also depicts bending magnets 130 used in the polyenergetic positive ion selection process.

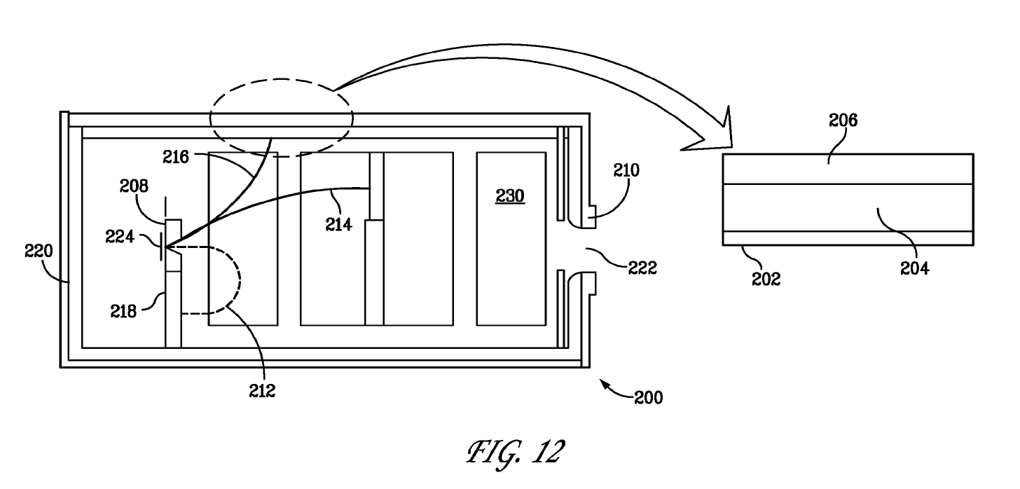

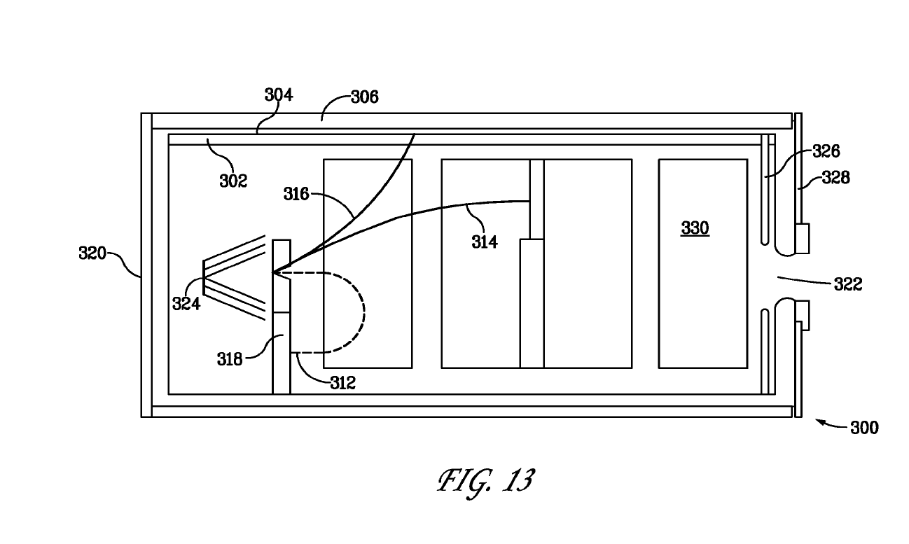

Referring to FIG. 12, the layers of the radiation shield 200 are arranged so that at least a portion of the low energy neutron shielding layers 204 is disposed closer to the polyenergetic positive ion source than the high energy photon shielding layers 206. FIG. FIG. 12 demonstrates one suitable arrangement of the low energy neutron shielding layer 204 in relation to the high energy photon shielding layer 206.

The low energy neutron shielding layer 204 is suitably closer to the polyenergetic positive ion source than the high energy photon layer. Without being bound by any particular theory of operation, it is believed that when low energy neutrons are slowed down and absorbed in shielding materials, they undergo some reactions with the shielding material and release high energy gamma rays, or photons. Thus, the photon shielding layer can be disposed behind the neutron shielding layer to stop the gamma rays generated by these reactions.

At least a portion of the one or more low energy proton shielding layers 202 is disposed on the interior of the radiation shield 200 in the direction of deflection of the low energy protons 216. FIG. 12 shows the low energy protons 216 being deflected “up” and the first layer of shielding they encounter is the low energy proton shielding 202 and the high energy protons 214 being deflected by the bending magnets 230 into the energy selection collimator. Also depicted in FIG. 12 are the exit collimator 210 which aids in the selection of polyenergetic positive ions and the electron beam stopper 218 which absorbs the electrons after they have completed their 180 degree turn. An entry opening 220 is provided to permit the entry of a laser pulse to the target 224 a source of polyenergetic positive ions, and an exit opening 222 for permitting polyenergetic positive ions to exit the radiation shield 200

Referring to FIG. 13, a suitable radiation shield 300 includes at least a portion of the one or more high energy neutron shielding layers 328 being at least a portion of the one or more high energy proton shielding layers 326 are disposed on the interior of the exit face of the radiation shield 300. FIG. 13 demonstrates an example of placement of the one or more high energy neutron shielding layers 328 and the one or more high energy proton shielding layers 326.

To create the polyenergetic positive ions source, a target 324 is irradiated with a suitable femto second pulsed laser, which laser pulse passes through an entry opening 320. Interaction between the laser pulse, the metal target, and hydrogen and other atoms adsorbed on, or proximate to, the metal target gives rise to a cloud of electrons 312. The cloud of electrons 312 creates an electric field and pulls the polyenergetic positive ions off of the source, which positive ions eventually exit the radiation shield 300 through exit opening 322. These electrons 312 and polyenergetic positive ions then pass into a magnetic field produced by a bending magnet 330. This magnetic field separates the polyenergetic positive ions and allows the selection of the proper energy level, the high energy protons 314 are deflected into the energy selection collimator. At the same time the electrons 312 are turned in opposite directions. One or more electron shielding layers 318 is needed here to absorb these electrons 312. The one or more electron shielding layer 318 may comprise a tungsten, or similar material, member between about 1 cm and about 10 cm thick, preferably between about 2 cm and 7 cm thick

As the polyenergetic positive ions pass through the magnetic field of the first bending magnet 330 the slower (lower energy) protons are deflected into the top wall of the radiation shield 300. These low energy protons 316 have an energy level less than about 50 MeV. A low energy proton shield layer 302 is required to absorb these particles. The one or more low energy proton shielding layers 302 may comprise steel, tungsten, copper, zinc, lead, other high density materials, or any combination thereof. High density materials suitably include materials that have a density above about 10 g/cm³. The one or more low energy proton shielding layers 302 may comprise a layer between about 0.2 cm and about 5 cm thick.

The absorption of protons and other particles into the radiation shield 300 may give rise to the production of secondary particles, including low energy neutrons, high energy neutrons, and high energy photons. Appropriate shield layers are suitably provided for each type of secondary particle.

The one or more low energy neutron shielding layers 304 suitably comprise low density, hydrogen-rich materials. Suitable low density, hydrogen-rich materials include boronated polyethylene, polypropylene, polyethylene, polystyrene, PMMA, and various other plastic materials, or any combination thereof. Concrete may also be used if weight and compactness are not primary concerns in the radiation shield 300. The neutron shielding layers can be between about 5 cm and about 20 cm thick depending on the exact material used. The low energy neutrons have a typical high energy in the range of from about 0.025 eV to about 5 MeV.

Suitable high energy neutron shielding layers 328 comprise tungsten, steel, copper, lead, or any combination thereof. Materials that have similar neutron inelastic scattering cross sections to tungsten, lead, copper, steel, or any combination thereof are also appropriate. Suitable high energy neutron shielding layers 328 comprise a layer between about 5 cm and about 20 cm thick. High energy neutrons are characterized as having energy in the range of from about 5 MeV to about 350 MeV.

High energy photons include bremsstrahlung photons, gamma rays, or both. Suitable high energy photon shielding layers 306 comprise steel, tungsten, copper, zinc, lead, other high density materials, or any combination thereof. Suitable high energy photon shielding layers 306 include one or more materials having an atomic number greater than about 26. Suitable thicknesses for the one or more high energy photon shielding layers 306 are between about 2 cm and about 40 cm thick. High energy photons are characterized as having energy in the range of from about 1 MeV to about 350 MeV.

These and other aspects of the present invention will readily be apparent to those skilled in the art in view of the following drawings and detailed description. The summary and the following detailed description are not to be considered a restriction of the invention as defined in the appended claims and serve only to provide examples and explanations of the invention.

### Examples and Other Illustrative Embodiments

Recently, proton acceleration using laser-induced plasmas has garnered interest. Both theoretical and experimental studies have been carried out to accelerate protons or light ions using high-power, short-pulse lasers. The idea of laser acceleration was first proposed in 1979 for electrons and rapid progress in laser-electron acceleration began in the 1990's after chirped pulse amplification (CPA) was invented and convenient high-fluence solid-state laser materials such as Ti:sapphire were discovered and developed. The mechanism for proton acceleration is well studied. It has long been understood that ion acceleration in laser-produced plasma relates to the hot electrons. A laser pulse interacting with the high-density hydrogen-rich material (like plastic or water vapor on the surface of a metal foil) ionizes it and subsequently interacts with the created plasma. The commonly recognized effect responsible for ion acceleration is charge separation in the plasma due to high-energy electrons, driven by the laser inside the foil and an inductive electric field as a result of the self-generated magnetic field.

Examples of design and dose calculations of suitable shielding systems for laser-accelerated proton radiation therapy facility are provided herein. For conventional cyclotron or synchrotron based proton therapy facility, the shielding calculations have to consider beam losses occurring during injection, RF capture, acceleration, transfer and delivery. In the design of laser-proton therapy unit, laser is transported directly to the gantry. The target foil assembly and the beam selection device are placed on the rotating gantry, and the laser beam reaches the final focusing mirror through a series of mirrors. The radiation shield for a suitable laser-accelerated proton therapy facility typically needs to take into account particle generation and transport inside the treatment gantry.

In certain illustrative embodiments, and without being bound by any limiting theory of operation, it is believed that both electron and proton emissions from the target foil can be forward peaked along the axis of the laser beam and have a wide angular spread. Most of the primary charged particles are typically stopped in the primary collimator except a small fraction which passes into the particle selection system due to their angular distribution. As these high energy protons and electrons come to rest, a fraction undergo nuclear interactions that release high-energy neutrons, posing a radiation shielding challenge due to their abundance and highly penetrating nature. Bremsstrahlung radiation from the electron beam is another concern in shielding design since a significant fraction of the incident laser energy transfers to electrons which have maximum energy almost the same as the protons. Accordingly, a major concern of laser-proton radiation therapy system shielding design needs to address secondary neutrons and bremsstrahlung photons generated at the primary collimator, within a particle selection system, or both.

Suitable criteria for laser proton therapy facility shielding design is gantry head leakage dose equivalent of less than about 0.1% of therapeutic absorbed dose.

A compact device for particle selection and beam modulation, which utilizes a magnetic field to spread the laser-accelerated protons spatially, based on their energies and emitting angles, and apertures of different shapes to select protons within a therapeutic window of energy and angle is described in “High Energy Polyenergetic Ion Selection System, Ion Beam Therapy Systems, and Ion Beam Treatment Centers”, by Ma, U.S. Pat. App. Pub. No. 2006/0145088A1, the entirety of which is incorporated by reference herein. Such a compact device eliminates the massive beam transportation and collimating equipment in a conventional proton therapy system. The laser-proton target assembly and the particle selection and collimating device can be installed in the treatment gantry to form a compact treatment unit, which may be installed in a radiotherapy treatment room.

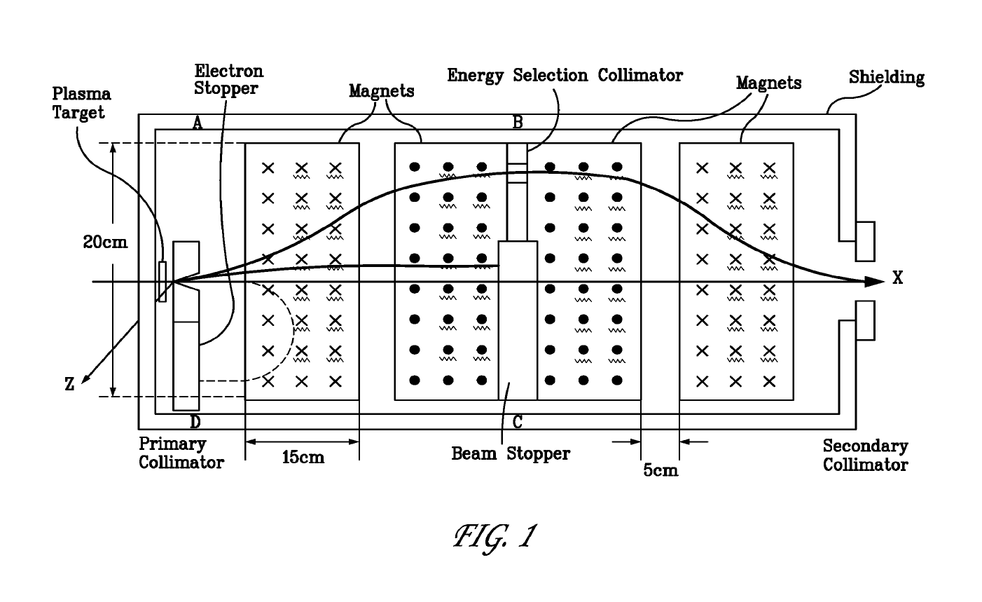

A schematic diagram of an embodiment of a radiation shield substantially enclosing a source of polyenergetic positive ions is shown in FIG. 1. This radiation shield comprises a series of bending magnets that produce four separated magnetic fields. The particles produced by a high intensity laser include not just protons, but also electrons which are believed to give rise to the electrostatic field that accelerates the protons. Particles coming from the thin foil target (“plasma target”) are mainly accelerated forward peaked along the direction normal to the target surface and enter magnetic fields with a small angular spread. Without being bound by any theory of operation, the Lorentz force of the field spreads the protons out, so that lower energy protons have larger angular deflection, thus achieving a desired spatial separation. Protons of energies within a selected energy range are allowed to pass through the energy selection collimator and refocused through a secondary collimator. Beam selection collimators of different shapes, sizes and locations can be used to select particles of desired energies. Other protons are stopped by the energy selection collimator or shielding walls depending on their energies. Electrons are deflected downward by the magnetic field and absorbed by an electron beam stopper or shielding walls. In some embodiments, a broad angular distribution of the accelerated protons gives rise to a spatial mixing of different energy protons as they go through the magnetic field. To reduce the spatial mixing of protons a primary collimation device may be used to collimate protons to the desired angular distribution. To achieve an effective proton spatial differentiation, it is desirable to have a small collimator opening. Accordingly, most of the protons and electrons are stopped by a primary collimator and gives rise to a major source of secondary neutrons and bremsstrahlung X-rays. A primary collimator that produces fewer secondary particles and is capable of greater local attenuation is desirable to reduce shielding stress.

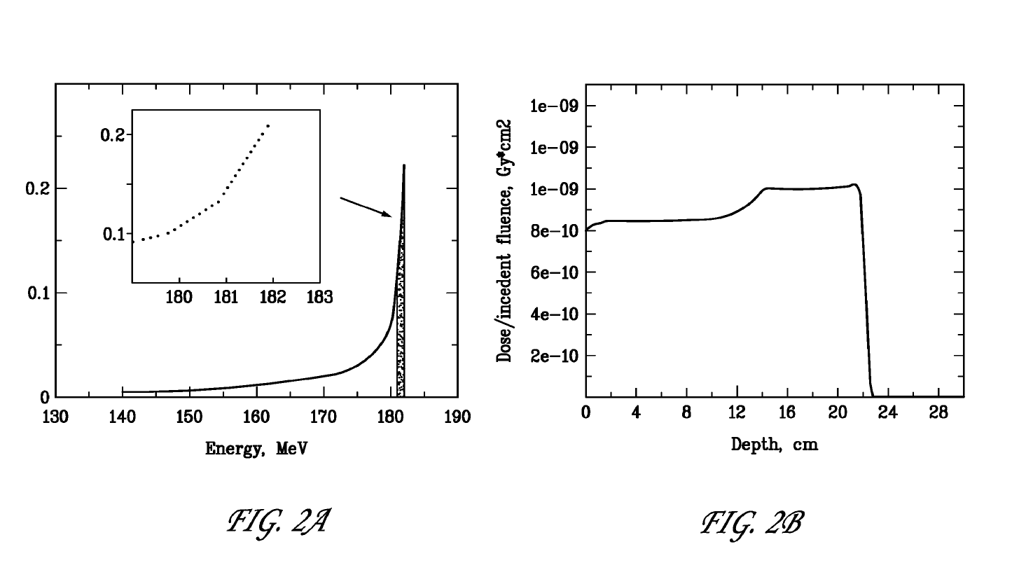

Usually the energy range of protons utilized in proton therapy ranges from 60 MeV to 250 MeV. That covers tumors between about 2 cm to about 38 cm depths. In this embodiment, simulations were performed with a 2×10²¹ W/cm² intensity linearly polarized laser pulse with pulse width of 14, 35 and 49 femtoseconds. For these laser/plasma parameters chosen in the simulation, the maximum proton energy reaches the value of 140 MeV, 230 MeV and 300 MeV, respectively. Since the neutron multiplicity is a strong function of proton energy, the 300 MeV spectrum was chosen for analysis. FIG. 2 shows the energy distributions for the protons and electrons accelerated by this laser pulse in the shielded energy selector system of FIG. 1. The proton energy profile exhibits a long tail with a cutoff at around 300 MeV, which is a characteristic energy spectrum of electrostatically accelerated protons.

As mentioned earlier, the broad energy spectrum of laser protons provides opportunities for selecting protons of proper energies to deliver dose distributions with desired spread out Bragg peaks (SOBP). Using the particle selection devices described herein, proton energies can be modulated to deliver the SOBP in a given target's depth dimension. And because of the angular distribution of laser protons, different field sizes are directly achieved by adjusting the open angle of the primary collimator without a beam scattering system. But at the same time, it also means only a small fraction of protons can pass through the magnetic fields for final collimation, most of the primary charged particles will be stopped by collimators and beam stoppers. Neutrons and photons generated in their slowing down process pose a challenge in shielding design.

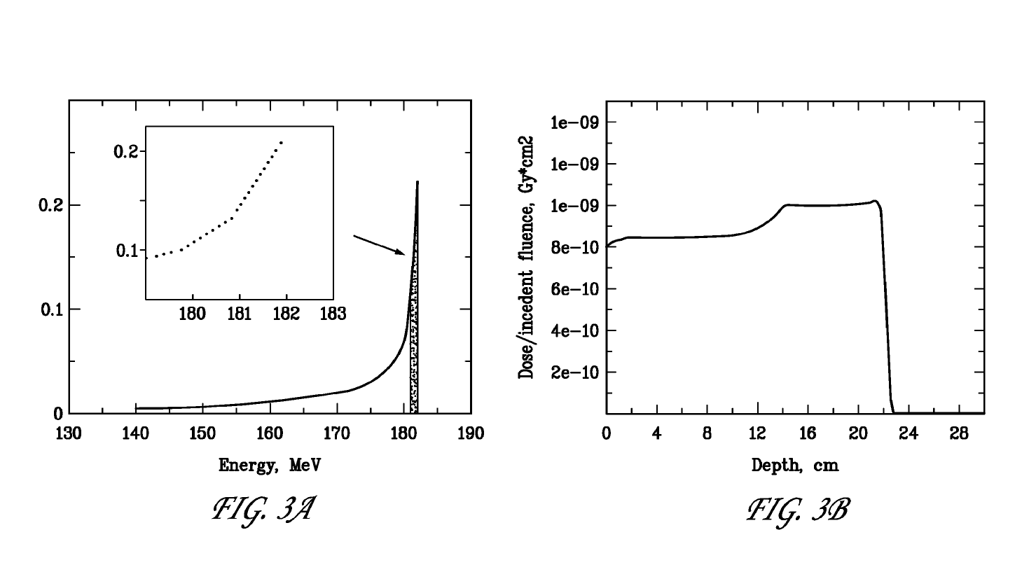

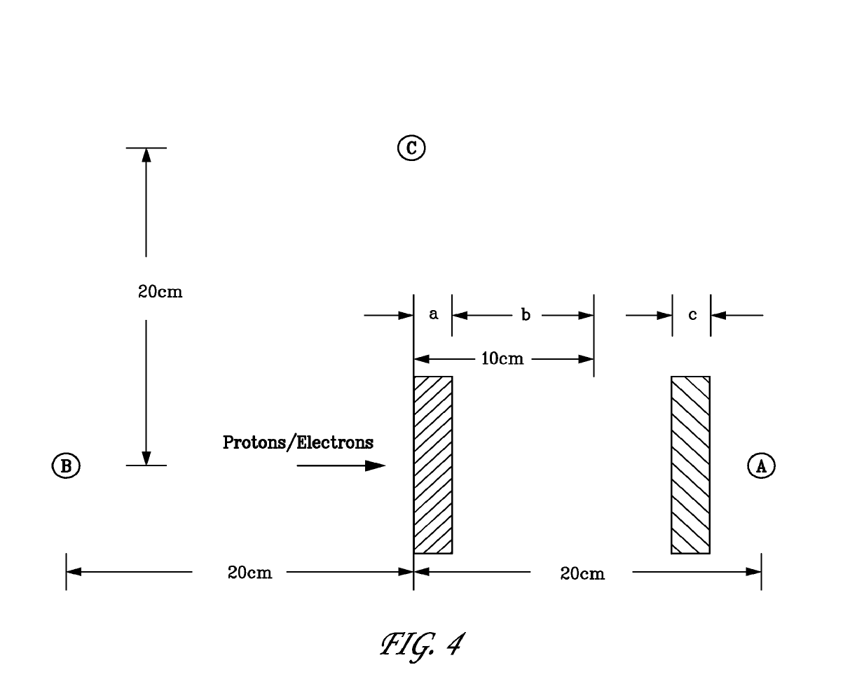

An important issue that needs to be considered carefully for designing laser proton shielding is the total number of initial particles required to deliver 1 Gy dose at the target region. For a target with a spatial depth dimension of 7 cm, located at depth lying between 14 cm and 22 cm, the energy range of polyenergetic protons required to cover this target is 140 MeV<E<182 MeV. By using Monte Carlo simulations, the calculated dose deposited by protons in this depth range with SOBP is 1×10⁻⁹ Gycm² per initial proton. FIG. 3(A) provides a proton energy distribution to generate the SOBP shown in FIG. 3(B) based on 4×4 cm² field size defined at 100 cm SSD. In the spectrum to generate SOBP dose distribution, higher energy protons are used in greater amount than lower energy protons. The highest energy bin uses the largest number of protons because lower energy protons have almost no dose contribution to the Bragg peak position of highest energy protons. The Bragg peak position is primarily determined from the dose from higher energy protons. There are about 16.8% protons in the energy bin 181 MeV<E<182 MeV in this distribution. From laser proton energy spectrum shown in FIG. 2(A), there are about 0.023% protons with energy in range of 181 MeV<E<182 MeV. To form a 4×4 cm² field at 100 cm SSD, a primary collimator can suitably have an opening angle of 0.02 rad. From PIC simulation we know that protons with outcoming angle less than 0.02 rad is about 12% of total amount. With these in mind, the total number of initial protons needed to deliver 1 Gy dose to target can be estimated in the following way. To deliver 1 Gy at plateau part of SOBP for 4×4 cm² field size, N₁=16×10⁹protons are needed where the number of protons in energy range 181 MeV<E<182 MeV is N₂=N₁×16.8%=2.688×10⁹. Considering there are only 0.023% of protons with energy in range of 181 MeV<E<182 MeV in the laser proton spectrum, the proton number in the whole spectrum can be calculated by N₃=N₂/0.023%=1.169×10¹³. Finally the total number of initial protons is calculated as Nₚ=N₃/12% 32 9.7×10¹³. Since only less than 0.02% protons can go through the final secondary collimator and deposit dose to target, it is well enough to assume 88% protons will be stopped by the primary collimator and rest 12% will be stopped by the particle selection system in this calculation.

As mentioned above, without being bound by any theory of operation, the commonly recognized effect responsible for proton acceleration in laser-produced plasma attributes to high-energy electrons 212, driven by the laser inside the target 224 foil. Refer to FIG. 12. Although as different target 224 design and laser system may be used, protons and electrons 212 output can be different. About 10% of laser pulse energy goes to accelerate protons while 30% to 40% goes to accelerating electrons 212. The electron yield was assumed to be the maximum of that range, or 40% of initial laser pulse energy. The protons and electrons average energy can be derived by the energy spectrum shown in FIG. 2, where protons average energy is 35.8 MeV and electrons average energy is 22.9 MeV. To deliver 1 Gy dose to target, the total number of electrons accelerated by a laser can be estimated by Nₑ=(9.7×10¹³×35.8/10%)×40%/22.9=6.06×10¹⁴. The ratio of electrons 212 stopped by primary collimator 208 and by particle selection system can be considered the same as protons since they have similar angular distribution.

In general, there are four sub sources in laser-proton therapy facility shielding calculation: protons at the primary collimator 208, protons in the particle selection system, electrons 212 at the primary collimator 208 and electrons 212 in the particle selection system. These are referred to herein as primary proton source, secondary proton source, primary electron 212 source and secondary electron 212 source, respectively.

An embodiment of a suitable radiation shield for a laser proton therapy facility according to the present invention can take into account both neutron/photon generation and elimination. Proton range decreases with increasing material density which suggests fabricating a collimator with a high density material such as brass, lead or tungsten. However, high density material usually is also high Z material which has strong multiplicity ability of neutrons and X-rays. In order to reduce neutron/photon contamination while keeping the whole system compact, different potential materials and their combinations for fabricating the collimator were carefully tested.

Neutron shielding requires material rich of hydrogen, while x-ray shielding material needs mass and high atomic numbers. One can use a separate material for the two purposes or materials that are good shields for both neutrons and X-rays.

A number of materials that have been considered in these examples include: machinable tungsten alloy, lead, copper, steel, polyethylene and borated polyethylene (BPE). Machinable tungsten (Mi-Tech HD-18.5 alloy, 97% W, 0.9% Fe, 2.1% Ni) has a very high density of 18.5 g/cm³ and is an effective beam stopper for charged beam and an excellent shielding material for X-rays where space is at a premium. The range of maximum energy electrons (270 MeV) in machinable tungsten is about 1.4 cm, while the range of the maximum energy protons (300 MeV) is about 5.3 cm. Tungsten also has strong ability to reduce neutron energy for high energy neutrons by inelastic scattering, the half energy layer value is only about 50% of lead and steel for 10 MeV neutrons.

Lead has a high density of 11.35 g/cm³ which is a good shielding material for X-rays. Compared to tungsten, lead is relatively cheaper and much easier to shape. Copper and steel have similar shielding ability for MeV X-rays and reduce the neutron energy by inelastic scattering for high energy neutrons (greater than 5 MeV). Steel is also a good structural material.

Polyethylene (CH₂) is an excellent neutron shielding material. It is available either pure (p=0.92 g/cm³) or loaded with varying percentages of boron to increase the thermal neutron capture ability. Standard borated polyethylene (BPE, 11.6% H, 61.2% C, 5% B, 22.2% O; p=0.93 g/cm³) is commercially available and contains 5 percent boron by weight.

All the dose calculations were performed using the Fluka Monte Carlo code (version 2006.3). Fluka is a code covering an extended range of applications spanning from proton and electron accelerator shielding to target design, calorimetry, activation, dosimetry, detector design, comic rays, neutrino physics, and radiotherapy etc. With the support of CERN and INFN, Fluka has been extensively bench-marked against experimental data over a wide energy range for both hadronic and electrometric showers. It is equipped with different user selectable particle transport modes. Suitable particle transport modes include a SHIELEINg mode, and preferably a HARDROTHErapy mode that includes a low energy neutron transport and low particle cut-off energy threshold. HARDROTHErapy mode was selected for the simulations described herein. Photonuclear physics was also turned on in HARDROTHErapy mode to determine the dose component due to photon-neutron production by bremsstrahlung X-rays.

Neutron and photon fluence at the various tally locations was converted to dose equivalent by Fluka through the specification of suitable conversion functions in these simulations. For neutron fluence, the NCRP-38 conversion function was used. Because it is a maximum dose equivalent quantity, NCRP-38 provides a more conservative estimate of dose equivalent above several MeV than does ICRP-60 ambient dose equivalent, which is referenced to a 1 cm depth in an ICRU phantom. For photon fluence, the ICRP-74 conversion function for effective dose, AP exposure geometry, was used. The choice of anterior-posterior exposure geometry gives the largest effective dose for a given fluence distribution. However, the maximum photon energy listed in ICRP74 is only 10 MeV while the bremsstrahlung X-ray spectrum extends to electron maximum energy. For photons with energy higher than 10 MeV, conversion coefficients were taken from Fluka calculation which has similar values in low energy part with ICRP74 and expends energy range up to 100 GeV.

Several variance reduction techniques were used to make the dose calculation process more efficient. First, in the case of proton source term, a global cutoff energy of 7 MeV was used to terminate transport for any sampled particle at or below that energy. The rationale for doing so is that in order to induce spallation neutrons, the proton energy should exceed the average nucleon binding energy. Second, since neutron production varies as the second power of proton energy, the proton energy distribution was biased to improve sampling in the high-energy bins of the distribution which are responsible for most of the neutron production. Third, as neutrons are the major concern of shielding calculations, a special technique in Fluka named multiplicity tuning was used to make the neutron generation from hadron or photon-neutron interactions more efficient. Furthermore, the importance of biasing and biasing mean free path (exponential transform) were also used in order to improve scoring efficiency at several tally locations. The application of variance reduction techniques in conjunction with a sufficient number of transport histories give a statistical uncertainty of less than 5% (1 σ) for all major tally results.

Referring to FIG. 9 the design of primary collimator 108 for laser-proton therapy facility includes consideration of both collimator 108, 109, 110 thickness and composition. To study the effect of potential collimating materials on neutron production and elimination, calculations of neutron spectra and neutron dose equivalent spectra were made for steel, copper, lead and tungsten. Ranges of 300 MeV protons in the four materials are 9.4 cm, 8.5 cm, 8.9 cm and 5.3 cm respectively. The simulated primary collimator 108 has a cross-section of 10×10 cm² and 10 cm in length which can fully stop all the protons. Three tally cells (A, B and C) were located 20 cm away from center of primary collimator 108 left surface with a radius of 2 cm. The calculated neutron spectra are distributed from thermal energies to the proton maximum energy (300 MeV). Because neutrons with energies of less than 10 keV do not contribute appreciably to the total neutron dose equivalent, the spectra are plotted in the 10 keV and 300 MeV neutron energy interval.

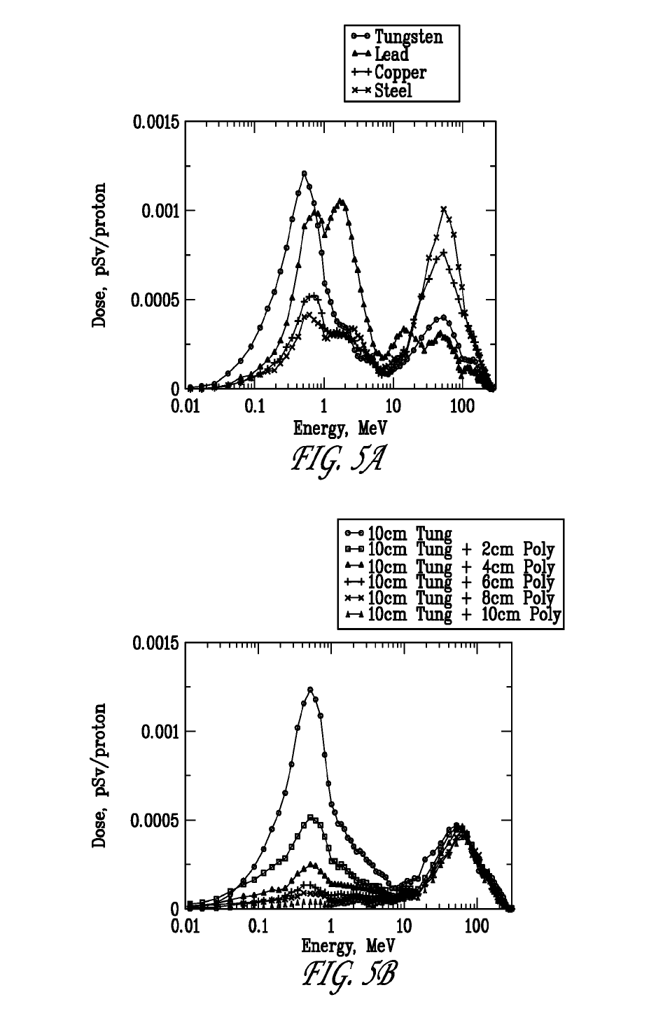

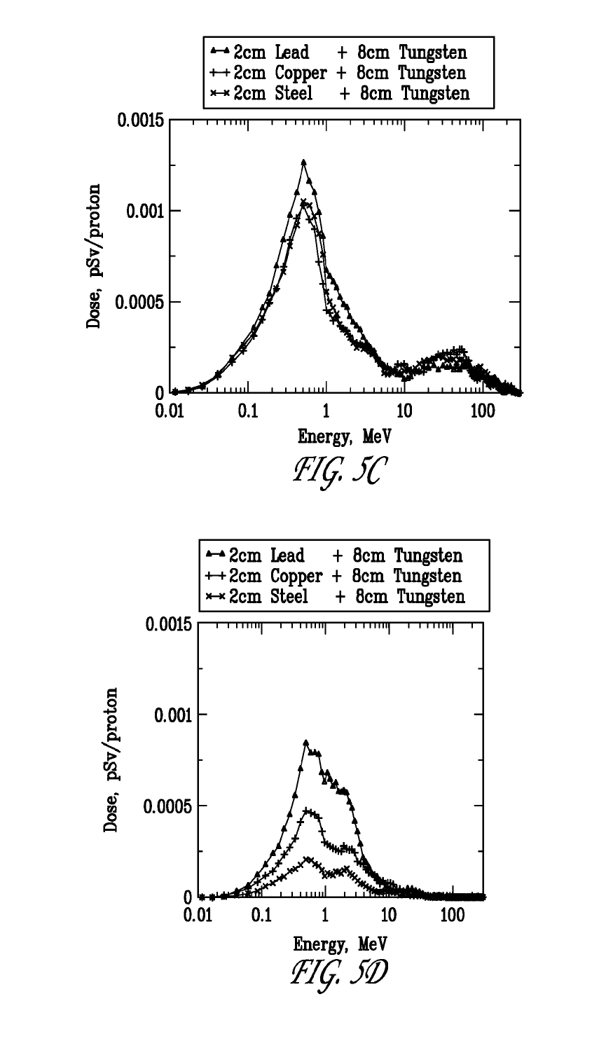

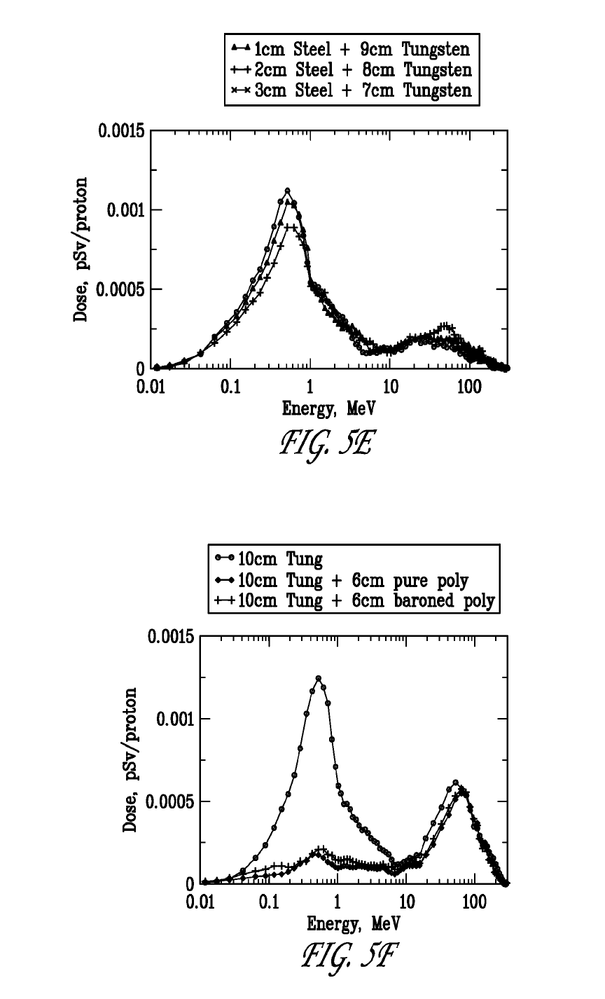

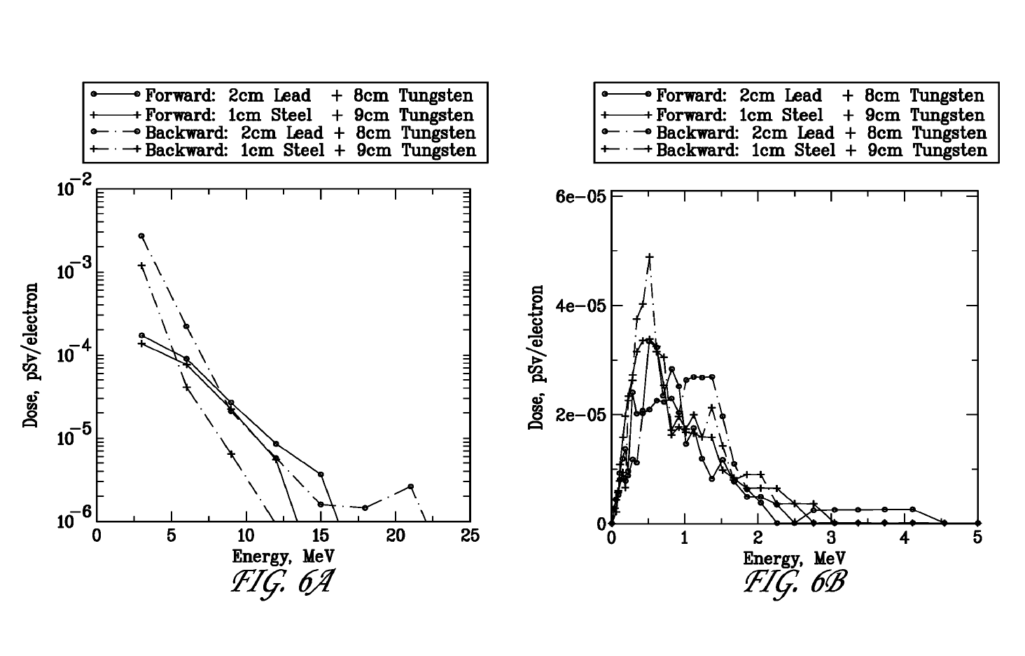

The neutron spectra for all four materials were dominated by two large peaks: a high energy peak centered at approximately 50 MeV produced by forward-peaked proton-nucleus reactions and a lower energy peak centered at about 0.6 MeV, mainly produced by isotropic evaporation processes when high energy neutrons slowing down in the material. FIG. 5(A) plots the neutron dose equivalent spectra per proton at detector A with unique material collimator 108, 109, 110 design (a=0 cm, b=10 cm, c=0 cm). This figure indicates that tungsten and lead are good materials in slowing down high energy neutrons (greater than 10 MeV) to energy of several MeV while lead doesn't perform well at the MeV energy range.

Further investigations were carried out to find out how thick of a neutron absorption material is needed to eliminate these neutrons. A polyethylene layer 104 located between the primary collimator 108 and detector A with different thickness of 2 cm, 4 cm, 6 cm, 8cm and 10 cm were used in the calculations. FIG. 5(B) shows the lower energy peak of dose equivalent spectra drops dramatically as the polyethylene layer 104 gets thicker but high energy peak decreases slowly. A polyethylene layer 104 between about 8 cm and about 10 cm thick is good enough to absorb neutrons with energies of several MeV and lower but is still nearly transparent for very high energy neutrons. Tungsten is a good material for decreasing the energy of high energy (greater than 10 MeV) neutrons. But introducing more tungsten by making the primary collimator 108 thicker is not desirable because of the limited space inside the gantry. Putting a lot of tungsten into the surrounding wall is also not desirable because of its high cost and heavy weight.

A composite collimator design was evaluated to reduce the production of high energy neutrons while keep the system compact. According to the data shown in IAEA Technical Report Series 283, the neutron yield per proton shows a mild Z dependence of approximately Z^{1/2}, and a strong dependence on proton energy of Eₚ². Essentially all of the neutron production takes place early in the slowing down process of the proton beam. So better performance of a well-designed two layers composite collimator results compared to a unique material collimator. In this design, the first layer consist of relatively low Z materials which slows down high energy protons with less neutron production compare to high Z materials. Lead is a high Z material but its high energy neutron production is relatively low, so lead can also be considered as a first layer material candidate. The second layer using materials with large neutron inelastic scattering cross-sections like tungsten can be used to slow down high energy neutrons. The neutron dose equivalent spectra at the forward direction (detector A) and backward direction (detector B) by different composite collimator 108, 109, 110 designs are shown in FIG. 5(C) and FIG. 5(D). Forward high energy penetrating neutron dose are greatly reduced for all the three composite collimators 108, 109, 110. However, a steel+tungsten composite collimator has much less back scattering neutron dose which makes it to be best design of the three. The effect of steel/tungsten thickness ratio was also investigated. As shown in FIG. 5(E), a different thickness ratio has an opposite impact on high energy dose peak and low energy dose peak. 1 cm steel and 9 cm tungsten composite is considered to be slightly better than the other two choices since high energy neutrons are our major concern.

The neutron shielding abilities of pure polyethylene and standard 5% borated polyethylene (BPE) are compared in FIG. 5(F). BPE has a larger thermal neutron capture cross-section while pure polyethylene performs better in the energy range of from about 0.01 MeV to about 300 MeV since it contains more hydrogen. To reduce the neutron dose equivalent as much as possible, pure polyethylene was selected as the major neutron shielding material in our design.

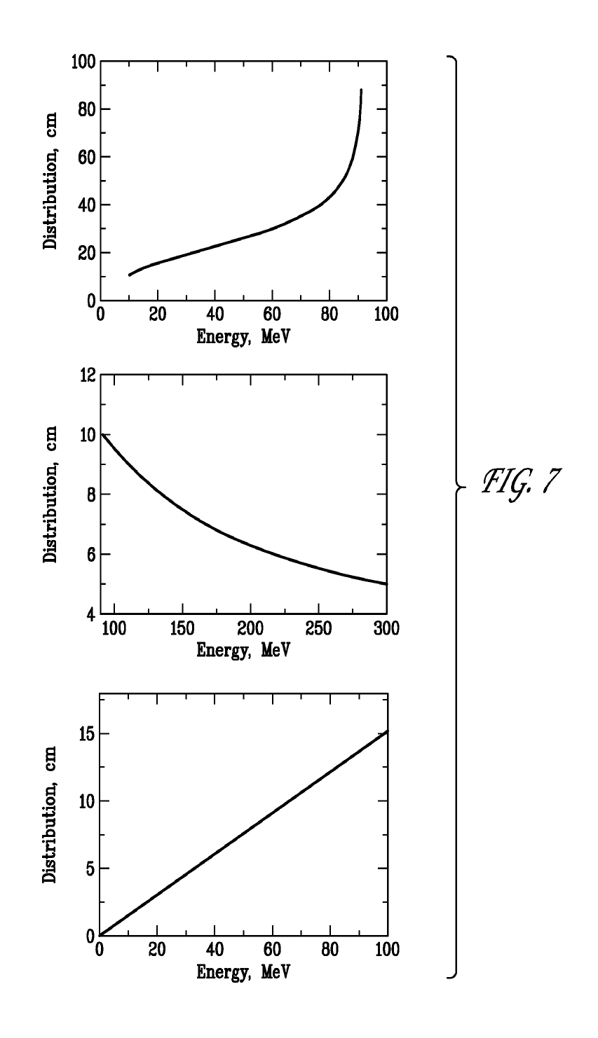

Photon dose comes from the electron beam slowing down process in the primary collimator and is another issue since the tremendous number of incident electrons. FIG. 6(A) shows the photon dose equivalent spectra at the forward (detector A) and backward direction (detector B) with two composite collimator designs. The steel+tungsten design has less photon dose than the lead+tungsten design at both directions since bremsstrahlung generation features a Z² dependence and Compton scattering cross-section proportion to material density. Bremsstrahlung self absorption in the primary collimator can greatly reduce the shielding requirement. Tungsten is a very effective shielding material for MeV photons which can reduce photon dose by more than three orders of magnitude in 8 to 9 cm thickness. This is another reason of choosing steel+tungsten composite collimator design. Neutrons generated by photonuclear interactions were also studied. As shown in FIG. 6(B), compared to neutrons that come from proton-nuclear interactions, photo-neutrons have lower energies and much less dose contribution which can be shielded by polyethylene easily.

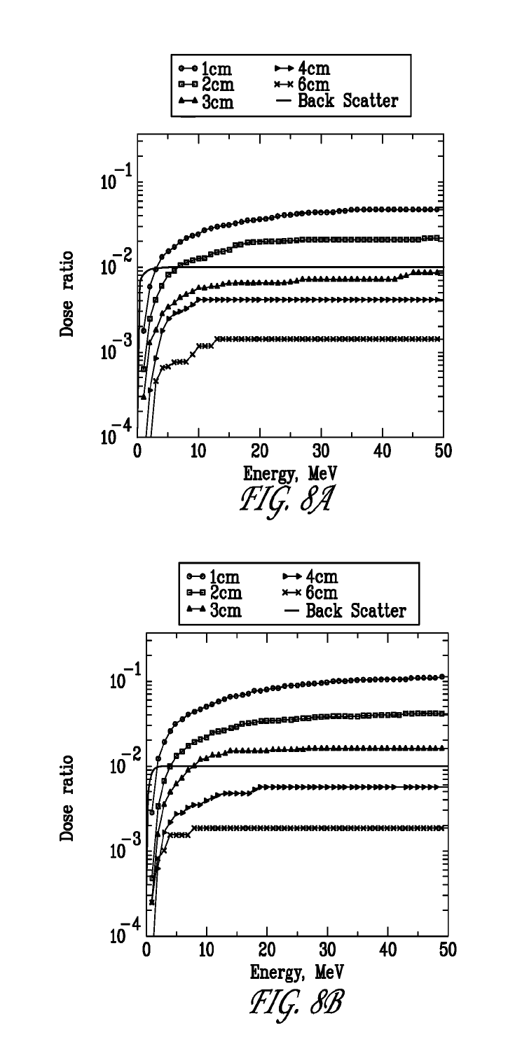

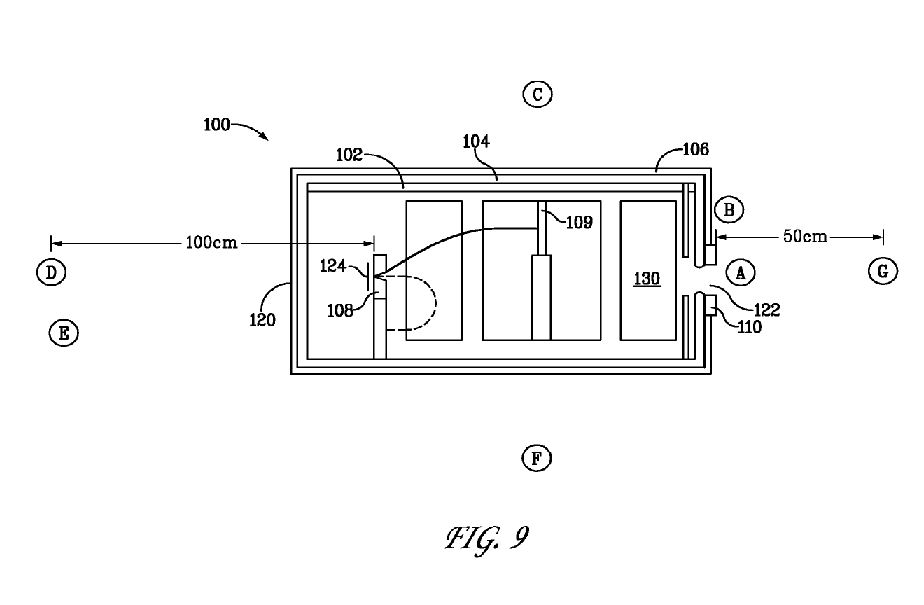

Particles entering magnetic fields in the beam selection system will be deflected by Lorentz forces and will have a spatial distribution arising from their energy spread. Different spatial distributions can be achieved by changing the strength of the magnetic fields used in the beam selection system. Magnets for generating ˜4.4 T magnetic field by using NbTi superconducting wires are commercially available and can be implemented in the system. As shown in FIG. 1, protons with positive charge will go upwards and most of them will be stopped by a suitable energy selection collimator or shielding wall while electrons with negative charge will go downwards and most of them will be stopped by a suitable electron stopper. FIGS. 7a,b show one dimension protons spatial distribution on the surface of energy selection collimator and shielding wall as a function of proton energy. Protons with energy above about 92 MeV reach the energy selection collimator and are useful in treatment. The tungsten energy selection collimator was designed to be 5.3 cm thick as the maximum energy protons (300 MeV) has a range of about 5.3 cm in tungsten. It will be a conservative way to assume energy selection collimator is totally closed in our calculation since all the protons will be stopped in particle selection and collimation system in this way. A thinner collimator may be used for compactness and flexibility. If so, the transmitted low-energy protons will have to be shield further downstream. Low energy protons are deflected to larger angles and have a wide spatial distribution along the surface of up shielding wall. For example, referring to FIG. 9, a 2 cm thick steel layer 102 on the inner side of the top wall is designed to stop these protons (e.g., 92 MeV proton has a range of about 1.25 cm in steel). Neutron dose comes from proton interactions with particle selection system will be presented and discussed below.

Different from protons, electrons having the same energy have much less mass while receiving a stronger Lorentz force because of their faster speed. Most of the electrons even cannot pass across the first magnetic field. These electrons perform a ˜180 degree rotation in the first magnetic field and reverse their direction as shown in FIG. 1. A tungsten electron stopper is designed right below the primary collimator to stop these electrons. FIG. 7c shows electron spatial distribution on the right surface of primary collimator and electron stopper. Only electrons with energy above ˜90 MeV can go further and reach shielding wall or even the beam stopper below energy selection collimator. Effect of these electrons is neglectable as their small amount ratio with the whole spectrum (<0.2% according to FIG. 2 b).

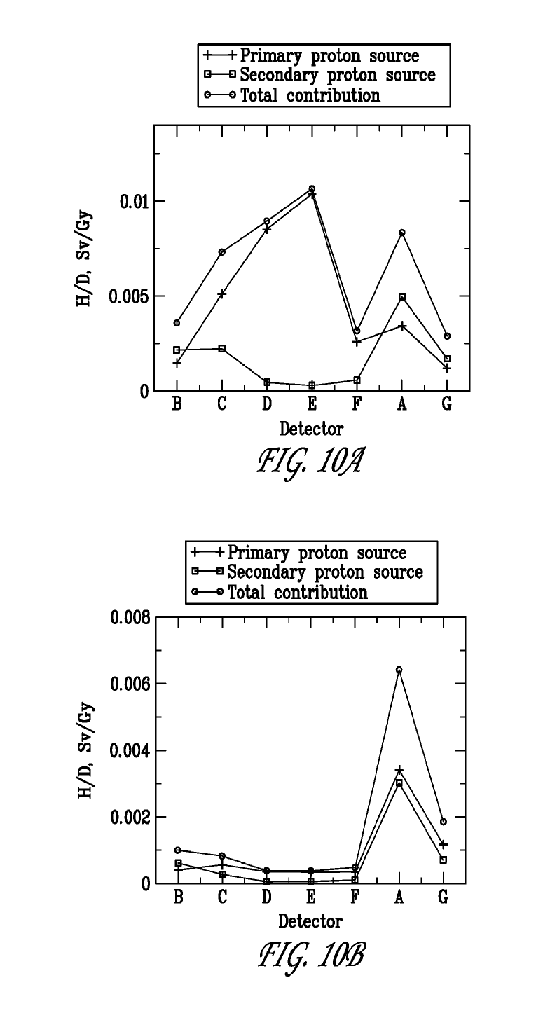

Bremsstrahlung photon dose per therapeutic absorbed dose (H/D) at detector D, E is plotted in FIG. 8 to illustrate the influence of electron beam stopper thickness on H/D values. Dose from primary electron source at the same location is also plotted in FIG. 8 as a reference. D, E are located at the same positions as shown in FIG. 9 while there is no shielding material between detector and electron beam stopper. The H/D value reduces very quickly as beam stopper thickness increases. A 3˜4 cm tungsten layer is typically thick enough to make dose be comparable to photon backscatter dose from primary collimator. However considering these transmission photons have higher average energy, a 6 cm thick electron beam stopper was used in this embodiment.

Total photon and neutron dose equivalent per therapeutic absorbed dose. Suitable radiation shields of the present invention ensure that head leakage is less than 0.1% of therapeutic absorbed dose. To achieve this, multiple layered shielding around a particle selection system can be used. As shown in the embodiment of FIG. 9, the system is surrounded by a polyethylene layer 104 and an outer lead layer 106. The polyethylene layer 104 is the major shielding for neutrons while lead is efficient to shield bremsstrahlung photons by electron source and gamma rays from (n,γ) reaction. A special 4 cm tungsten layer on the inner side of right shielding wall is designed to slow down high energy neutrons produced by secondary proton source. Detector cells B-F with a radius of 2 cm are located around the system at a distance of 100 cm from the center of primary collimator 108 left surface to monitor leakage dose. Detector A and G are used to estimate potential extra dose to patient where A is located right after secondary collimator 110 and G is located 50 cm away along beam direction. Results shown below are expressed in dose equivalent per therapeutic absorbed dose (H/D).

To evaluate the necessary thickness of shielding materials, a three step calculation strategy was carried out in designing a suitable radiation shield. Considering most of the x-ray photons from electron source are absorbed by primary collimator 108 and electron beam stopper, the radiation shield accounts mainly for neutron and photon dose from proton beam. First, neutron H/D from proton beam at different locations without shielding was calculated to estimate the necessary thickness of polyethylene layer 104 in neutron shielding. Second, include polyethylene layer 104 into calculation geometry, photon H/D from thermal neutron capture was calculated to estimate the necessary thickness of lead layer 106. Finally, do whole system simulation including all the shielding layers and components inside gantry for both proton and electron source and calculate total dose of each point to find out whether the designed shielding layer thickness are enough or not.

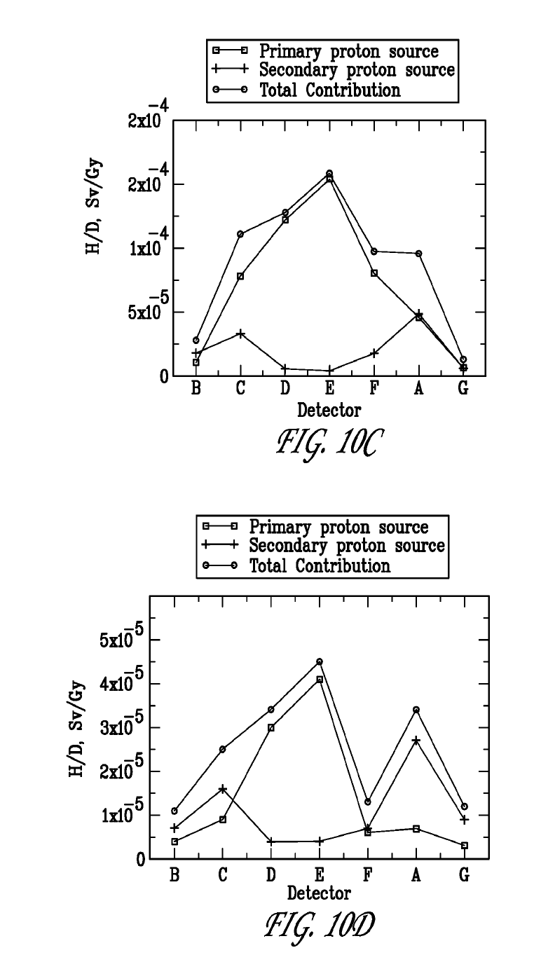

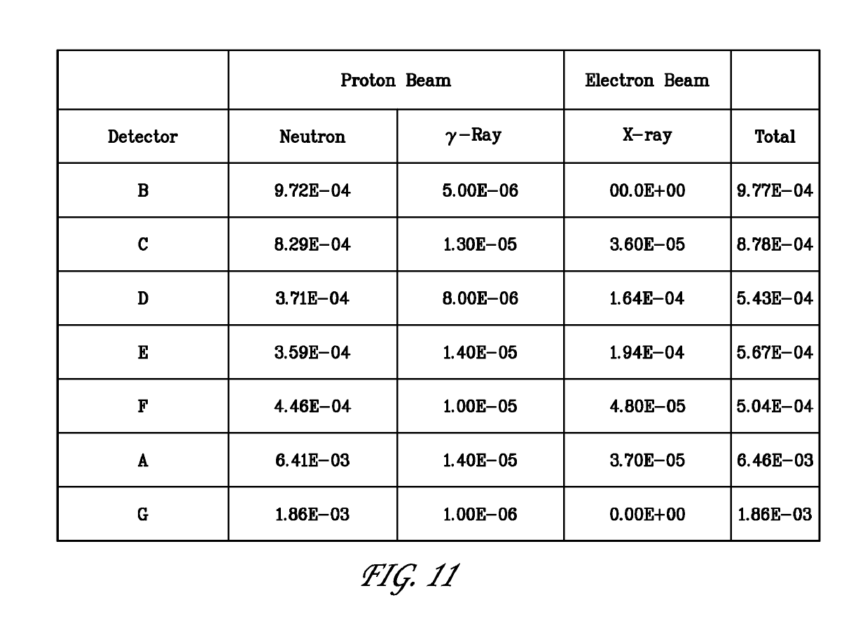

FIG. 10a shows neutron dose equivalent per therapeutic dose at different locations without shielding. The H/D values ranged from approximately 0.3% to 1% which means neutron dose has to be reduced by at least 10˜20 times. The maximum values of H/D recorded at detector points D and E are mainly attributed to backscatter neutrons from primary collimator. As shown in FIG. 5d, most of the backscatter neutrons have energies that range from about 0.1 MeV to about 10 MeV which can be effectively absorbed by polyethylene.

Based on these data, a radiation shield which covers the beam selection system with polyethylene 12 cm on the left side and 10 cm for the others was tested. As shown in FIG. 10b, contributions from primary proton source and secondary proton source are listed separately. Total neutron H/D values are within 0.1% for all the positions. Dose equivalent reduced by factors of about 15˜20 at detectors D and E. However at detector point B, neutrons are much more difficult to be shielded because of their higher energies. Accordingly, different designs of composite primary collimator were needed to be evaluated to reduce high energy neutrons.

Thermal neutron capture in shielding materials releases γ rays by (n,γ) reaction. Major thermal neutron capture happens in polyethylene is H(n,γ) reaction which will release 2.22 MeV γ ray. Tenth value of lead for 2.22 MeV photon is about 4.4 cm. To estimate the necessary thickness of lead shielding layer, γ ray dose at different locations produced by thermal neutron capture in polyethylene layer were calculated and shown in FIG. 10c. By comparing FIGS. 10a and 10c, we found generally γ ray dose is proportion to neutron dose. Although dose contribution from thermal neutron capture γ ray is relatively low, a 3 cm lead layer was added to cover polyethylene layer since this lead layer is also used to shield X-ray photons come from primary and secondary electron source.

X-ray dose from electron beam source was calculated with both polyethylene layer 104 and lead shielding layer 106 taken into account. As shown in Table 1, the maximum dose was recorded at detector E which comes from electron bremsstrahlung and backscatter photon. Compare to proton beam source, dose contribution from electron beam source is much smaller and can be further reduced easily by adding a little more lead shielding 106. Photon-neutron dose already becomes undetectable after polyethylene layer 104 and lead shielding layer 106. Total dose equivalent per therapeutic absorbed dose (H/D)ₜₒₜ and its composition from different sources are listed in Table 1. The maximum value of (H/D)ₜₒₜ happens at detector B, which is also below 0.1% criteria.

Discussion of Results. The dose equivalent leakage rates for the treatment head presented in Table 1 can be interpreted as maximum values, based on conservative assumptions made throughout the analysis. Effect of self shielding in the form of bending magnet structures and internal baffles was also ignored. The shielding calculation accounts for the proton energy spectrum arising from laser acceleration. Laser-proton spectrum is strongly related with target foil design. The exponential energy spectrum used in this calculation is based on single layer flat target design which has almost 100% energy spread. Other designs have been evaluated and generally generate proton spectra worse than this, which is considered unacceptable. A laser-driven quasi-monoenergetic ion beam with a vastly reduced energy spread of 17% may also use a heated-up double layer target design. A leading short bunch of ions shows a monoenergetic energy distribution with a mean energy of E≈36 MeV and a full-width at half-maximum of 6 MeV can be provided. Such quasi-monoenergetic ion sources may enable significant advances in beam delivery and reduce shielding requirement distinctly.

Currently used 0.1% head leakage per therapeutic absorbed dose criteria is mainly designed for 3D-CRT treatment technique. In cases where the beam is modulated by either MLC or a physical compensator, the actual dose due to leakage radiation can be increased by the modulation scaling factor (MSF) for photon beam. Similar leakage radiation increment was found if scanning beam delivery is used for laser-proton therapy facility. Although there is no requirement of taking account of MSF in radiation therapy facility radiation shield, we can estimate the potential leakage dose increment if scanning beam delivery technique is used in laser-proton system. For laser-proton system, modulation scaling factor value depends on the maximum target cross section area perpendicular to beam direction. It is well enough to assume an averaged MSF of 10 if 1×1 cm² pencil beam is used in scanning. As discussed above, particle number ratio of secondary source and primary source is mainly decided by field size. Smaller field size or smaller opening angle of primary collimator means fewer particles can enter the particle selection system. Leakage dose contribution from secondary source is neglectable for 1×1 cm² field in simple estimation. A factor of 1.14 (12%/88%=0.14) can be used in this estimation by assuming all the particles from laser acceleration are stopped by primary collimator. According to data shown in FIG. 10b and Table 1, maximum leakage dose at position B has 40% dose contributed by primary source. So roughly leakage dose increment can be estimated in this way: 9.77E−04×40%×1.14×10=4.45E−03 Sv/Gy .

Although the head leakage requirement is set out for the region outside the boundary of the secondary collimator, leakage dose contribution inside treatment field was also estimated in this research. Results are shown in FIG. 10 and Table 1. Total dose decreases quickly as the distance to secondary collimator increases. Since the ratio of total dose at detector A and detector G is 1.86/6.46=0.288, the total leakage dose inside field falls off as r^{-3.07} where r is the distance from primary collimator. According to some published studies available for conventional proton therapy facility, neutron dose to patients treated with passively scattered beams ranges from 10⁻⁴ Gy to 10⁻² Gy per therapeutic Gy at 50 cm distance from nozzle. Neutron leakage inside field for laser-proton system is already at the lower boundary of this range assuming a quality factor of 15.

The radiation shield for a laser-accelerated proton system was evaluated for intensity modulated radiation therapy. Previously studied particle selection system is capable of delivering clinically relevant proton beams that can be used to produce excellent radiation therapy treatments while at the same time, the treatment head leakage can be limited to meet the radiation shield criteria. Monte Carlo calculations using several variance reduction techniques were performed. Several commonly used shielding materials were carefully compared to make the whole system compact.

It was found that the use of a composite collimator design could greatly reduce high energy neutron dose contributions without increasing primary collimator size. A two layer shielding was evaluated. Overall results suggest that polyethylene layer of 10˜12 cm and lead layer of 4 cm thick are enough to shield laser-accelerated proton therapy system with head leakage in the regulatory dose limits.

The most recent experiment results have generated protons with energies up to 60 MeV using petawatt laser Higher proton energy output is expected as more powerful laser and better system design are achieved. For example, numerical simulations have investigated laser/foil parameter range that can lead to effective proton acceleration. It was found that thin foils (0.5-1 μm thick) with electron densities of nₑ=5×10²² cm⁻³ and laser pulse intensity I=10²¹ W cm⁻² and length L=50 femtosecond are amenable to effective proton acceleration capable of producing protons with energies 200 MeV and higher. The results of these studies suggested that future experimental investigations should concentrate on the irradiation of thin foils with ultra short high-intensity lasers. According to these simulations, it was shown that due to the broad energy spectrum and large angular distribution of the accelerated protons, it is difficult to use them for therapeutic treatments without prior proton energy selection and collimation. Once such an energy distribution is achieved, it is possible to give a homogeneous dose distribution through the so-called spread out Bragg's peak (SOBP). The conformal dose distribution to the target laterally can be achieved by using multiple beams, for example, to modulate proton intensity.

What is claimed:

1. A radiation shield substantially enclosing a source of polyenergetic positive ions, comprising:
one or more electron shielding layers;
one or more low energy proton shielding layers;
one or more high energy proton shielding layers; and
wherein said shielding layers are spatially arranged to absorb substantially all unwanted radiation arising directly or indirectly from the polyenergetic positive ions.

2. The radiation shield of claim 1, further comprising secondary particle shielding layers.

3. The radiation shield of claim 2, wherein the secondary particle shielding layers comprise one or more low energy neutron shielding layers, one or more high energy neutron shielding layers, one or more high energy photon shielding layers, or any combination thereof

4. The radiation shield of claim 1, wherein at least a portion of the one or more low energy neutron shielding layers is disposed closer than the one or more high energy photon shielding layers to the polyenergetic positive ion source.

5. The radiation shield of claim 1, wherein at least a portion of the one or more low energy proton shielding layers is disposed on the interior of the radiation shield in the direction of deflection of the low energy positive ions.

6. The radiation shield of claim 1, wherein the one or more electron shielding layers comprises tungsten, or a similar material, member between about 2 cm and about 7 cm thick.

7. The radiation shield of claim 1, wherein the one or more low energy neutron shielding layers comprise low density, hydrogen-rich materials.

8. The radiation shield of claim 7 wherein the low density, hydrogen-rich materials comprise boronated polyethylene, polyethylene, polystyrene, PMMA, plastic materials, or any combination thereof.

9. The radiation shield of claim 1, wherein one or more of the electron shielding layers, the low energy proton shielding layers, or the high energy proton shielding layers comprises concrete.

10. The radiation shield of claim 7 wherein the one or more low energy neutron shielding layers comprise a layer between about 5 cm and about 20 cm thick.

11. The radiation shield of claim 7 wherein the low energy neutrons are characterized as having energy in the range of from about 0.025 eV to about 5 MeV.

12. The radiation shield of claim 1, wherein the one or more high energy neutron shielding layers comprise tungsten, steel, copper, lead, or any combination thereof.

13. The radiation shield of claim 12, wherein the one or more high energy neutron shielding layers comprise materials that have similar neutron inelastic scattering cross sections to tungsten, lead, copper, steel, or any combination thereof.

14. The radiation shield of claim 12 wherein the one or more high energy neutron shielding layers comprise a layer between about 5 cm and about 20 cm thick.

15. The radiation shield of claim 12 wherein the high energy neutrons are characterized as having at least one energy in the range of from about 5 MeV to about 350 MeV.

16. The radiation shield of claim 1, wherein the one or more low energy proton shielding layers comprise steel, tungsten, copper, zinc, lead, other high density materials, or any combination thereof.

17. The radiation shield of claim 16, wherein the high density materials comprise materials that have a density above about 10 g/cm³.

18. The radiation shield of claim 16 wherein the one or more low energy proton shielding layers comprise a layer between about 0.2 cm and about 5 cm thick.

19. The radiation shield of claim 16 wherein the low energy protons are characterized as having at least one energy less than about 50 MeV.

20. The radiation shield of claim 1, wherein the one or more high energy photon shielding layers comprise steel, tungsten, copper, zinc, lead, the other high density materials, or any combination thereof.

21. The radiation shield of claim 20, wherein the one or more high energy photon shielding layers comprise one or more materials having an atomic number greater than about 26.

22. The radiation shield of claim 20, wherein the high energy photons comprise bremsstrahlung photons, gamma rays, or both.

23. The radiation shield of claim 20 wherein the one or more high energy photon shielding layers comprise a layer between about 2 cm and about 40 cm thick.

24. The radiation shield of claim 20 wherein the high energy photons are characterized as having at least one energy in the range of from about 1 MeV to about 350 MeV.

25. The radiation shield of claim 1, further comprising an opening to permit entry of a laser pulse to the source of polyenergetic positive ions, and an opening for permitting polyenergetic positive ions to exit the radiation shield.

26. The radiation shield of claim 1, wherein the opening to permit entry of a laser pulse is characterized as having an area from about 1 cm² to about 1600 cm².

27. The radiation shield of claim 1, wherein the opening for permitting polyenergetic positive ions to exit the radiation shield is characterized as having an area from about 0.01 cm² to about 1600 cm².

28. The radiation shield of claim 1, wherein at least a portion of the one or more high energy neutron shielding layers and at least a portion of the one or more high energy photon shielding layers are situated proximate to the opening for permitting polyenergetic positive ions to exit the radiation shield.

29. The radiation shield of claim 1, wherein the one or more low energy proton shielding layers are situated proximate to the direction of deflection of low energy positive ions.

30. The radiation shield of claim 1, wherein the dimensions of the radiation shield are less than about 5 meters long by 5 meters wide by 5 meters high.

31. An ion selection system comprising the radiation shield of claim 1.

32. A method of shielding unwanted radiation leaking from a system capable of providing a therapeutic dose of polyenergetic positive radiation, the method comprising:
stopping or slowing, or both, electrons using one or more electron shielding layers contained within the system;
stopping or slowing, or both, low energy protons using one or more low energy proton shielding layers contained within the system; and
stopping or slowing, or both, high energy protons using one or more high energy proton shielding layers contained within the system.

33. The method of claim 32, further comprising stopping or slowing, or both, secondary particles using one or more secondary particle shielding layer contained within the system.

34. The method of claim 32, wherein the secondary particles comprise low energy neutrons, high energy neutrons, high energy photons, or any combination thereof

35. The method of claim 32, wherein the unwanted radiation dose leaking from the system is less than about 0.1% of the therapeutic dose adsorbed by a patient.

36. A polyenergetic positive ion selection system, comprising:
a source of polyenergetic positive ions; and
a radiation shield substantially enclosing the source of polyenergetic positive ions, the radiation shield comprising:
one or more electron shielding layers;
one or more low energy proton shielding layers; and
one or more high energy proton shielding layers;
wherein said shielding layers are spatially arranged to absorb substantially all unwanted radiation arising directly or indirectly from the polyenergetic positive ions.

37. The system of claim 36, further comprising secondary particle shielding layers to absorb substantially all unwanted radiation arising directly or indirectly from the polyenergetic positive ions.

38. The system of claim 36, wherein the secondary particles comprise low energy neutrons, high energy neutrons, high energy photons, or any combination thereof.
